(19) United States
(12) Patent Application Publication
(10) Pub. No.: US 2021/0140580 A1
(43) Pub. Date: May 13, 2021

(54) ACCESSORY ATTACHMENT FOR A PORTABLE ELECTRONIC DEVICE

(71) Applicant: PopSockets LLC, Boulder, CO (US)

(72) Inventors: Altan Nahum, Boulder, CO (US); Thomas Meiser, Boulder, CO (US); David B. Barnett, Boulder, CO (US); Nathan Cook, Boulder, CO (US)

(21) Appl. No.: 17/021,535

(22) Filed: Sep. 15, 2020

Related U.S. Application Data
(60) Provisional application No. 62/933,058, filed on Nov. 8, 2019.

(51) Int. Cl. F16M 11/20; F16M 11/04; A45F 5/00

(52) U.S. Cl. CPC F16M 11/2092; F16M 11/041; A45F 2200/0516; A45F 5/00; F16M 2200/027; F16M 11/205

(57) ABSTRACT

An accessory attachment device includes a platform having top and bottom sides, an elongated length, a platform height dimension, and at least one engaging region that engages an outer edge of the portable electronic device or a case thereof. The platform height dimension is less than a device height dimension of the portable electronic device.

### CROSS REFERENCE TO RELATED APPLICATION

Priority is claimed to U.S. Provisional Patent Application No. 62/933,058, filed Nov. 8, 2019, the entire contents of which are hereby incorporated herein by reference

### FIELD OF THE INVENTION

The present disclosure generally relates to an accessory attachment device and, more particularly, to slidable attachment devices that can be removably attached to a portable electronic device or a case for a portable electronic device and used as grips, stands, or for other purposes.

### BACKGROUND

Portable electronic devices, such as MP3 players and smart phones, are often housed in protective covers or cases in order to protect the device from damage, provide a grip for handling the device, and/or provide a stand for propping the device on a surface. Such cases increase the effective size of the device. Expandable devices and accessories, which may be attached directly to the device or to the case protecting the device, are used for a variety of functions, including propping the device on a surface and providing an expandable grip for handling the device. The expandable devices have decorative buttons, which may display logos, decals, symbols, or other artistic renderings.

### SUMMARY

In accordance with one aspect, an accessory attachment device includes a platform having top and bottom sides, an elongated length, a platform height dimension, and at least one engaging region that engages an outer edge of the portable electronic device or a case thereof. The platform height dimension is less than a device height dimension of the portable electronic device.

In some examples, the device further includes a grip device adapted to be removably coupled with the accessory attachment device. The grip device may include a body and a button. The body may include first and second ends and a longitudinal axis and may be coupled with the platform. The body is movable between expanded and collapsed configurations. The button is operably coupled with the first end of the body.

In some examples, the device further includes a plurality of engaging regions disposed on opposing ends of the elongated length of the platform. The engaging region or regions are adapted to frictionally engage the outer edge of the portable electronic device or the outer edge of the case for the portable electronic device. The platform may be slidably coupled with the portable electronic device.

In some examples, the platform is at least partially constructed from a resilient material. Further, in some forms, the body may further include a release mechanism that can releasably couple the body with the platform. Further, in some examples, the body and the button may cooperate to define a storage receptacle.

In some examples, the at least one engaging region includes a gripping material that contacts the outer edge of the portable electronic device or the outer edge of the case for the portable electronic device.

In accordance with a second embodiment, an accessory attachment device for attachment to a portable electronic device includes a platform having an elongated length, a platform height dimension, a top side, a bottom side, an adjustment mechanism, and at least one engaging region. The at least one engaging region is adapted to engage an outer edge of the portable electronic device or an outer edge of a case for the portable electronic device. The adjustment mechanism is adapted to selectively adjust a dimension of the elongated length of the platform between a clamped position and a released position.

In some of these examples, the device may further include a grip device adapted to be removably coupled with the accessory attachment device. The grip device may include a body and a button. The body includes a first end, a second end, and a longitudinal axis. The second end of the body is operably coupled with the platform. The body is movable between an expanded configuration and a collapsed configuration. The button is operably coupled with the first end of the body.

In some examples, the adjustment mechanism is in the form of a base and at least one arm movable relative to the base. The adjustment mechanism may further include a resilient member operably coupled with the base and the at least one arm to urge the base and the at least one arm towards the clamped position.

In some examples, the platform height dimension is less than a device height dimension of the portable electronic device. Further, in some examples, the at least one engaging region is adapted to frictionally engage the outer edge of the portable electronic device or the outer edge of the case for the portable electronic device.

In some forms, the body further includes a release mechanism that releasably couples the body with the platform. In some examples, the adjustment mechanism can also include a locking mechanism to selectively retain the platform in the clamped position or the released position.

In some examples, the adjustment mechanism may include at least one of a compliant member urged towards the clamped position, an adhesive member, a ratchet mechanism adapted to selectively retain the platform in the clamped position or the released position, a spring mechanism adapted to selectively retain the platform in the clamped position or the released position, or a cam mechanism adapted to selectively retain the platform in the clamped position or the released position.

In accordance with another embodiment, an accessory attachment device for attachment to a portable electronic device includes a platform and a bumper. The platform has an elongated length, a platform height dimension, a top side, a bottom side, and at least one engaging region. The at least one engaging region engages an outer edge of the portable electronic device. The bumper has a bumper body that is adapted to at least partially cover an outer edge of the portable electronic device and to at least partially cover a portion of the at least one engaging region.

In some of these examples, the device may further include a grip device adapted to be removably coupled with the accessory attachment device. The grip device may include a body and a button. The body includes a first end, a second end, and a longitudinal axis. The second end of the body is operably coupled with the platform. The body is movable between an expanded configuration and a collapsed configuration. The button is operably coupled with the first end of the body.

In some examples, the device may further include a track portion formed on the button to guide movement of the platform along the portable electronic device. Further, the bumper may be constructed from a resilient material.

In some examples, the body may further include a cover member adapted to at least partially cover a surface (e.g., a rear side) of the portable electronic device. The cover member may include a slotted portion to accommodate the at least one engaging region.

### BRIEF DESCRIPTION OF THE DRAWINGS

The above needs are at least partially met through provision of the accessory attachment device for a portable electronic device described in the following detailed description, particularly when studied in conjunction with the drawings, wherein:

FIG. 1 illustrates a perspective view of a first example accessory attachment device including a grip device and being coupled with a portable electronic device in accordance with various embodiments;

FIG. 2 illustrates a top plan view of the example accessory attachment device of FIG. 1 in accordance with various embodiments;

FIG. 3 illustrates a perspective view of the example accessory attachment device of FIGS. 1 and 2 in accordance with various embodiments;

FIG. 4 illustrates a perspective view of the example accessory attachment device of FIGS. 1-3 in a decoupled state in accordance with various embodiments;

FIG. 5 illustrates a front elevation view of the example accessory attachment device of FIGS. 1-4 in the decoupled state in accordance with various embodiments;

FIG. 6 illustrates a perspective view of the example accessory attachment device of FIGS. 1-5 in accordance with various embodiments;

FIG. 7 illustrates a perspective view of a second example accessory attachment device in accordance with various embodiments;

FIG. 8 illustrates a front elevation view of the example accessory attachment device of FIG. 7 in accordance with various embodiments;

FIG. 9 illustrates a perspective view of the second example accessory attachment device of FIGS. 7 and 8 in accordance with various embodiments;

FIG. 10 illustrates an exploded view of the second example accessory attachment device of FIGS. 7-9 in accordance with various embodiments;

FIG. 11 illustrates a cross-sectional view of the second example accessory attachment device of FIGS. 7-10 in accordance with various embodiments;

FIG. 12 illustrates a bottom plan view of the second example accessory attachment device of FIGS. 7-11 in accordance with various embodiments;

FIG. 13 illustrates an upper perspective view of a third example accessory attachment device in accordance with various embodiments;

FIG. 14 illustrates a lower perspective view of the third example accessory attachment device of FIG. 13 in accordance with various embodiments;

FIG. 15 illustrates an upper perspective view of a fourth example accessory attachment device in accordance with various embodiments;

FIG. 16 illustrates an upper perspective view of a fifth example accessory attachment device in accordance with various embodiments;

FIG. 17 illustrates an upper perspective view of a sixth example accessory attachment device in accordance with various embodiments;

FIG. 18 illustrates an upper perspective view of a seventh example accessory attachment device in accordance with various embodiments;

FIG. 19 illustrates an upper perspective view of an eighth example accessory attachment device in accordance with various embodiments;

FIG. 20 illustrates an upper perspective view of a ninth example accessory attachment device in accordance with various embodiments;

FIG. 21 illustrates an upper perspective view of a tenth example accessory attachment device in accordance with various embodiments;

FIG. 22 illustrates an upper perspective view of an eleventh example accessory attachment device in accordance with various embodiments;

FIG. 23 illustrates an upper perspective view of an twelfth example accessory attachment device in accordance with various embodiments;

FIG. 24 illustrates a lower perspective view of the twelfth example accessory attachment device of FIG. 23 in accordance with various embodiments;

FIG. 25 illustrates an upper perspective view of a thirteenth example accessory attachment device in accordance with various embodiments;

FIG. 26 illustrates a lower perspective view of the thirteenth example accessory attachment device of FIG. 25 in accordance with various embodiments;

FIG. 27 illustrates an upper perspective view of a fourteenth example accessory attachment device in accordance with various embodiments:

FIG. 28 illustrates a lower perspective view of the fourteenth example accessory attachment device of FIG. 27 in accordance with various embodiments;

FIG. 29 illustrates an upper perspective view of an fifteenth example accessory attachment device in accordance with various embodiments;

FIG. 30 illustrates a lower perspective view of the fifteenth example accessory attachment device of FIG. 29 in accordance with various embodiments;

FIG. 31 illustrates an upper perspective view of a sixteenth example accessory attachment device in accordance with various embodiments;

FIG. 32 illustrates a lower perspective view of the sixteenth example accessory attachment device of FIG. 31 in accordance with various embodiments;

FIG. 33 illustrates an upper perspective view of a seventeenth example accessory attachment device in accordance with various embodiments;

FIG. 34 illustrates a lower perspective view of the seventeenth example accessory attachment device of FIG. 33 in accordance with various embodiments;

FIG. 35 illustrates an upper perspective view of a eighteenth example accessory attachment device in accordance with various embodiments;

FIG. 36 illustrates a lower perspective view of the eighteenth example accessory attachment device of FIG. 35 in accordance with various embodiments;

FIG. 37 illustrates an upper perspective view of a nineteenth example accessory attachment device in accordance with various embodiments;

FIG. 38 illustrates a lower perspective view of the nineteenth example accessory attachment device of FIG. 37 in accordance with various embodiments;

FIG. 39 illustrates an upper perspective view of a twentieth example accessory attachment device in accordance with various embodiments;

FIG. 40 illustrates a lower perspective view of the twentieth example accessory attachment device of FIG. 39 in accordance with various embodiments;

FIG. 41 illustrates an upper perspective view of a twenty-first example accessory attachment device in accordance with various embodiments;

FIG. 42 illustrates a lower perspective view of the twenty-first example accessory attachment device of FIG. 41 in accordance with various embodiments;

FIG. 43 illustrates an upper perspective view of an twenty-second example accessory attachment device in accordance with various embodiments;

FIG. 44 illustrates a lower perspective view of the twenty-second example accessory attachment device of FIG. 43 in accordance with various embodiments;

FIG. 45 illustrates an upper perspective view of a twenty-third example accessory attachment device in accordance with various embodiments;

FIG. 46 illustrates a lower perspective view of the twenty-third example accessory attachment device of FIG. 45 in accordance with various embodiments;

FIG. 47 illustrates an upper perspective view of a twenty-fourth example accessory attachment device in accordance with various embodiments;

FIG. 48 illustrates a lower perspective view of the twenty-fourth example accessory attachment device of FIG. 47 in accordance with various embodiments;

FIG. 49 illustrates an upper perspective view of a twenty-fifth example accessory attachment device in accordance with various embodiments;

FIG. 50 illustrates a lower perspective view of the twenty-fifth example accessory attachment device of FIG. 49 in accordance with various embodiments;

FIG. 51 illustrates an upper perspective view of a twenty-sixth example accessory attachment device in accordance with various embodiments;

FIG. 52 illustrates a lower perspective view of the twenty-sixth example accessory attachment device of FIG. 51 in accordance with various embodiments;

FIG. 53 illustrates an upper perspective view of a twenty-seventh example accessory attachment device in accordance with various embodiments;

FIG. 54 illustrates a lower perspective view of the twenty-seventh example accessory attachment device of FIG. 53 in accordance with various embodiments;

FIG. 55 illustrates an upper perspective view of a twenty-eighth example accessory attachment device in accordance with various embodiments;

FIG. 56 illustrates a lower perspective view of the twenty-eighth example accessory attachment device of FIG. 55 in accordance with various embodiments;

FIG. 57 illustrates an upper perspective view of a twenty-ninth example accessory attachment device in accordance with various embodiments;

FIG. 58 illustrates a lower perspective view of the twenty-ninth example accessory attachment device of FIG. 57 in accordance with various embodiments;

FIG. 59 illustrates an upper perspective view of a thirtieth example accessory attachment device in accordance with various embodiments;

FIG. 60 illustrates a lower perspective view of the thirtieth example accessory attachment device of FIG. 59 in accordance with various embodiments;

FIG. 61 illustrates a perspective view of a thirty-first example accessory attachment device coupled with a portable electronic device in accordance with various embodiments;

FIG. 62 illustrates a perspective view of the thirty-first example accessory attachment device of FIG. 61 in accordance with various embodiments;

FIG. 63 illustrates a cross-sectional view of the thirty-first example accessory attachment device of FIGS. 61 and 62 in accordance with various embodiments;

FIG. 64 illustrates an isometric view of a thirty-fourth example accessory attachment device in accordance with various embodiments;

FIG. 65 illustrates an exploded view of the accessory attachment device of FIG. 64, including an example button, an example body including an example disk, an example hub, and an example platform in accordance with various embodiments;

FIG. 66 illustrates a front, cross-sectional view of the accessory attachment device taken at I-I of FIG. 64 in accordance with various embodiments;

FIG. 67 illustrates a side, cross-sectional view of the accessory attachment device taken at II-II of FIG. 64 in accordance with various embodiments;

FIG. 68 illustrates a front, cross-sectional view of the accessory attachment device of FIG. 64 in a collapsed configuration in accordance with various embodiments;

FIG. 69 illustrates a bottom view of the button of FIG. 64 in accordance with various embodiments;

FIG. 70 illustrates a top view of the connecting disk of FIG. 64 in accordance with various embodiments;

FIG. 71 illustrates a side view of the connecting disk of FIG. 70 in accordance with various embodiments;

FIG. 72 illustrates a isometric view of the hub of FIG. 64 in accordance with various embodiments;

FIG. 73 illustrates a bottom view of the hub of FIG. 72 in accordance with various embodiments;

FIG. 74 illustrates a top view of the platform of FIG. 64 in accordance with various embodiments;

FIG. 75 illustrates a side, cross-sectional view of the platform taken at III-III of FIG. 72 in accordance with various embodiments:

FIG. 76 illustrates a front, cross-sectional view of the platform taken at IV-IV of FIG. 72 in accordance with various embodiments;

FIG. 77 illustrates a front, cross-sectional view of an example accessory attachment device constructed in accordance with various embodiments;

FIG. 78 illustrates a side, cross-sectional view of the accessory attachment device of FIG. 77 in accordance with various embodiments; and

FIG. 79 illustrates a top view of a second example connector of the accessory attachment device of FIG. 77 in accordance with various embodiments.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, accessory attachment devices for portable electronic devices are provided that include a slidable platform and can additionally include a grip device having an expanding mechanism that is movable relative to the platform between a collapsed configuration and an expanded configuration. The accessory attachment devices, and more specifically, the grip devices may further include a button coupled to the expanding mechanism. The platform is dimensioned to engage an outer edge or periphery of a portable electronic device, or an outer edge or periphery of a case for a portable electronic device, and has a dimension (e.g., a height) that is less than a dimension (e.g., a height) of the portable electronic device.

A first embodiment of an accessory attachment device 100 in the form of an expandable grip device for use with a portable electronic device 10 is shown in FIGS. 1-6. The expandable grip device 100 includes a platform 102 having a top or upper side 102a and a bottom or lower side 102b, a collapsible and/or expandable mechanism or body 118 operably coupled to the platform 102, a button 117 having a top or upper side 117a and a bottom or lower side 117b. In some examples, the expandable grip device 100 further includes a storage receptacle 101 defined by the body 118 and/or the button 117.

The platform 102 may have any desired shape (e.g., an elongated generally rectangular shape) and is preferably constructed from metal or plastic material, though other suitable materials (e.g., cardboard) can be used. In some examples, the platform 102 is at least partially constructed from a resilient material. The platform 102 has an elongated length “L” and a platform height dimension “PH”. The bottom side 102b of the platform 102 is generally configured to abut the portable electronic device 10 (e.g., an MP3 player, a smart phone, a tablet) or a case of such a portable electronic device 10. The portable electronic device 10 has a device height dimension “DH”. The platform 102 additionally includes at least one engaging region 104 that, generally speaking, engages and/or secures with an outer edge 11 of the portable electronic device 10 (or an outer edge of a case for the portable electronic device).

The body 118 generally facilitates movement of the expandable grip device 100 between an expanded configuration (not illustrated) and a collapsed configuration (FIG. 5), and to retain the expandable grip device 100 in the desired configuration (expanded or collapsed). The body 118 may take the form of a tubular membrane, skin, curtain, case, enclosure, shell, cover, etc., and may include, surround, or contain a biasing member (e.g., a coil spring) that is arranged between the platform 102 and the button 117. As will be discussed with reference to FIGS. 64-79, the body 118 and/or the button 117 may be releasably coupled with the platform 102.

As stated, the button 117 includes the top or upper side 117a and the bottom or inner side 117b that define a lid and is operably coupled to the body 118. The button 117 may have an annular shape. In other examples, however, the button 117 may have a rectangular, square, triangular, irregular, or other shape. Like the platform 102, the button 117 is preferably constructed from metal or plastic material, though other suitable materials can be used.

The button 117 may be removable from the expandable grip device 100. The button 117 may have artistic value (e.g., the button 117 may include an artistic rendering, a logo, a symbol, text, or a decal), the button 117 may provide a grip that allows a user to slide their fingers between the bottom side 117b and the platform 102 when the body 118 is in the expanded configuration such that the top side 117a of the button 117 is disposed adjacent to the palm of the user's hand, and may also provide a space in which a cord, such as a cord for earphones, may be wrapped and stored around a portion of the platform 102. As such, in some examples, it may be desirable to remove the button 117 and replace it with another button 117 that features a different aesthetic design and/or provides a different grip so as to change the look and/or function of the expandable grip device 100.

As previously noted, the button 117 and/or the body 118 may define the storage receptacle 101 defining an interior volume to accommodate any number of items. For example, the storage receptacle 101 may be dimensioned to accommodate a cosmetic product, a food product, a fluid, a medicinal product, an electronic component, and/or any other suitable or desirable product. Cosmetic products may include lip balm, eye shadow, blush, mascara, hair gel, etc. Food products could include nutritional/energy gels, candy, powdered nutritional products, mints, gum, etc. Medicinal products might include an antibiotic salve, bug repellant salve or oils, after bite treatment, hydrocortisone cream, calamine lotion, sunscreen, etc. Other items such as ear rings, a spare key, etc. may also be stored in the compartment. The storage receptacle 101 may include partitions or other components (not shown) to assist in accommodating desired products such as, for example, different shades of a cosmetic product or different flavors of a lip balm. In some examples, the button 117 may include a mirror (not shown) on the inside and/or outside surface to assist in applying the cosmetic product to a user's face.

In operation, the expandable grip device 100 may be moved from the expanded configuration to the collapsed configuration by overcoming any biasing forces applied by resilient members. Generally speaking, the user of the expandable grip device 100 may accomplish this by grabbing or grasping the button 117 and moving (e.g., pushing) the button 117 towards the platform 102. The expandable grip device 100 may include any number of retaining components to maintain the expandable grip device 100 in the collapsed configuration. The button 117 may be positioned in the expanded configuration by grasping or pulling the button 117 away from the platform 102 with a sufficient force to overcome the force of any retaining components used to secure the expandable grip device 100 in the collapsed configuration. Upon doing so, if the expandable grip device 100 is equipped with a resilient member or members, the button 117 will be urged towards, and maintained in, an expanded configuration.

It is appreciated that in some examples, the devices described herein needn't be equipped with a body or a button. In these examples, the platform (e.g., the platform 102) may be used with any other suitable accessory (e.g., a battery, a wallet, a water bottle, an auxiliary screen, etc.) capable of at least temporarily coupling with the platform 102.

In the illustrated example, the platform 102 of the expandable grip device 100 includes two engaging regions 104, each of which is positioned at an end of the platform 102. The engaging regions 104 are in the form of curved members that are dimensioned to conform to and/or wrap around the outer edge 11 of the portable electronic device 10 (or an outer edge of a case for the portable electronic device if so equipped). In other examples, the engaging regions 104 may have a non-curved configuration but may still conform to and/or wrap around the outer edge 11 of the portable electronic device 10.

The platform 102 and the engaging regions 104 may be dimensioned such that they frictionally engage the outer edge 11 of the portable electronic device 10 to retain the expandable grip device 100 thereto. In some examples, the expandable grip device 100 may be dimensioned to be slidable along the height DH of the portable electronic device 10 while still being frictionally engaged therewith. More specifically, and as can be seen in the Figures, the platform height dimension PH may be less than the device height dimension DH. Accordingly, the expandable grip device 100 is movable relative to the portable electronic device 10. In some examples, the engaging regions 104 may include a gripping material 104a such as a tacky material, a temporary adhesive, and the like, that increases friction with the outer edge 11 of the portable electronic device 10.

In some examples, the engaging regions 104 may be constructed from a resilient material that allows a user to stretch the engaging regions outwardly to place the expandable grip device 100 around the portable electronic device 10. The resilience of the engaging regions 104 may cause them to “snap” back to engagement with the outer edge 11 of the portable electronic device 10. In other examples, the expandable grip device 100 may simply be slid over the outer edge 11 of the portable electronic device 10 at one of the ends thereof and subsequently slide the expandable grip device 100 to a desired position of the device height DH. Other examples are possible.

As illustrated in FIGS. 7-12, an alternative accessory attachment device 200 (illustrated without a body or button) in the form of an expandable grip device is provided. It will be appreciated that the expandable device 200 illustrated in FIGS. 7-12 may include similar features to the expandable device 100, and thereby elements illustrated in FIGS. 7-12 are designated by similar reference numbers indicated on the embodiment illustrated in FIGS. 1-6, increased by 100. Accordingly, these features will not be described in substantial detail.

In the expandable device 200, the platform 202 is adjustable to selectively shorten and/or lengthen elongated length L thereof. Accordingly, the expandable device 200 is capable of retaining portable electronic devices having differing dimensions. The platform 202 includes an adjustment mechanism 206 having a base 207 and at least one arm 208 which are coupled (and/or formed integrally) with the engaging regions 204. In the illustrated example, the adjustment mechanism 206 includes two arms 208. Generally speaking the arms 208 are movable relative to the base 207 between a clamped position and a released position. The clamped position has a reduced elongated length L compared to the released position.

The base 207 defines a base coupling portion 207a in the form of an elongated protrusion. The arms 208 define an arm coupling portion 208a in the form of an elongated groove or track that engages the base coupling portion 207a. Further, the base 207 includes a resilient member coupling portion 207b and any number of resilient member grooves 207c to accommodate a resilient member 209. Similarly, the arms 208 also include a resilient member coupling portion 208b and any number of resilient member grooves 208c. In the illustrated example, both the resilient member coupling portions 207b, 208b are in the form of a slot or a notch. It is appreciated that in the illustrated example, the arms 208 are generally U-shaped and are open to receive the base 207, but in other examples, an opposite arrangement is possible.

The resilient member 209 is in the form of an elastic band having any shape. The resilient member 209 is stretchable to engage both resilient member coupling portions 207b, 208b. Stretching the resilient member 209 over the resilient member coupling portions 207b, 208b urges the arms 208 inwardly to a clamped position. A user may pull or urge one or both of the arms 208 and/or engaging regions 204 outwardly relative to the base 207 to move the platform 202 to a released position. Increasing the length of the platform can allow the engaging regions 204 to be placed over the outer edge of the portable electronic device. Upon releasing the arms 208 (and/or the engaging regions 204), the resilient member or members 209 will urge the arms inwardly towards the clamped position to selectively grip the edge of the portable device. Depending on the desired strength of the resilient members 209, the engaging regions 204 may limit, reduce, and/or restrict the expandable device 200 from sliding along the device height of the device. A user may grasp one or both of the arms 208 and pull outwardly to move the platform to the released position in order to reposition the device 200 on the portable electronic device.

FIGS. 7-12 also illustrate a platform cover member 210 and engaging region cover members 211 for the platform 202 and the engaging regions 204 to provide an uninterrupted, smoother appearance. Notably, the platform cover member 210 includes an opening 210a to allow the release/securing mechanism to protrude therethrough to receive the body and the button.

As illustrated in FIGS. 13 and 14, an alternative accessory attachment device 300 (illustrated without a body or button) in the form of an expandable grip device is provided. It will be appreciated that the expandable device 300 illustrated in FIGS. 13 and 14 may include similar features to the expandable devices 100 and 200, and thereby elements illustrated in FIGS. 13 and 14 are designated by similar reference numbers indicated on the embodiment illustrated in FIGS. 1-12, increased by a multiple of 100. Accordingly, these features will not be described in substantial detail.

In the expandable device 300, the adjustment mechanism 306 is in the form of a geared connection having a locking mechanism. More specifically, a threaded or geared rotatable member 309 is disposed in the arms 308. The arms 308 also include protrusions 308a that slidably engage a corresponding track 307a formed in the base 307 to guide movement of the arms 308 relative to the base 307 along the elongated length L. The base 307 further includes a corresponding gear track 307b having gear teeth that engage the rotatable member 309.

The adjustment mechanism 306 may be adjusted by rotating the rotatable member 309 to engage the gear track 307b, which causes the rotatable member 309, and thus the arms 308 to move relative to the base 307 inwardly or outwardly, depending on a direction of rotation of the rotatable member 309. While the illustrated example uses a geared coupling, it is appreciated that any number of suitable retaining mechanisms may be used to secure the base 307 and the arms 308. The expandable device 300 may include illustrations 310 disposed on the arms 308 to identify the position and rotational movement needed to move the adjustment mechanism 306 between clamped and released positions. For example, the adjustment mechanism 3065 may move towards the clamped position by rotating the rotatable member 309 clockwise, and may move toward the released position by rotating the rotatable member counter-clockwise. The rotatable member 309 may be adjustable via a slot 309a thereon, which may be engaged with a screwdriver, a fingernail, a coin, etc. Other examples are possible.

As illustrated in FIGS. 15-20, alternative accessory attachment devices 400, 500, 600, 700, 800, and 900 (illustrated without a body or button) in the form of expandable grip devices are provided, respectively. It will be appreciated that the expandable devices 400, 500, 600, 700, 800, and 900 illustrated in FIGS. 15-20 may all include similar features to each other and to the expandable devices 100, 200, and thereby elements illustrated in FIGS. 15-20 are designated by similar reference numbers indicated on the embodiment illustrated in FIGS. 1-14, increased by multiples of 100. Accordingly, these features will not be described in substantial detail.

In the expandable devices 400, 500, 600, 700, 800, and 900, the adjustment mechanisms 406, 506, 706, 806, and 906 are in the form of compliant members having a variety of configurations and/or designs. More specifically, the platforms 402, 502, 602, 702, 802, 902 include a compliant portion 408, 508, 608, 708, 808, 908 constructed from a resilient material, the compliant portions 408, 508, 608, 708, 808, 908 include any number of void regions 408a, 508a, 608a, 708a, 808a, 908a that allow the compliant portions 408, 508, 608, 708, 808, 908 to expand and/or contract as desired.

In a resting configuration, the compliant portion 408, 508, 608, 708, 808, 908 may be dimensioned to be in the clamped position, and as such, the platform 402, 502, 602, 702, 802, 902 may be moved to the released position by pulling or urging the compliant portion 408, 508, 608, 708, 808, 908 outwardly to position the expandable device 400, 500, 600, 700, 800, 900 on the portable electronic device. Upon releasing the compliant portion 408, 508, 608, 708, 808, 908, the resilience thereof causes it to move or be urged back to the clamped position, thereby coupling with the engaging regions 404, 504, 604, 704, 804, 904 to couple and secure the expandable device 400, 500, 600, 700, 800, 900 with the portable electronic device.

As illustrated in FIGS. 21 and 22, alternative accessory attachment devices 1000 and 1100 (illustrated without a body or button) in the form of expandable grip devices are provided, respectively. It will be appreciated that the expandable devices 1000 and 1100 illustrated in FIGS. 21 and 22 may all include similar features to each other and to the expandable devices 100-900, and thereby elements illustrated in FIGS. 21 and 22 are designated by similar reference numbers indicated on the embodiment illustrated in FIGS. 1-20, increased by multiples of 100.

Accordingly, these features will not be described in substantial detail.

In the expandable devices 1000, 1100, the adjustment mechanism 1006, 1106 includes an adhesive member 1009, 1109 that selectively retains the arms 1008, 1108 in a desired position. With reference to the expandable device 1000 illustrated in FIG. 21, engagement tabs 1010 are provided that a user may grasp to release and/or move the arms 1008. The adhesive members 1009, 1109 may be in the form of a tacky material that maintains the adjustment mechanisms 1006, 1106 in a desired position, but can be overcome by a sufficient force.

As illustrated in FIGS. 23-30, alternative accessory attachment devices 1200, 1300, 1400, and 1500 (illustrated without a body or button) in the form of expandable grip devices are provided, respectively. It will be appreciated that the expandable devices 1200, 1300, 1400, and 1500 illustrated in FIGS. 23-30 may all include similar features to each other and to the expandable devices 100-1100, and thereby elements illustrated in FIGS. 23-30 are designated by similar reference numbers indicated on the embodiment illustrated in FIGS. 1-22, increased by multiples of 100. Accordingly, these features will not be described in substantial detail.

In the expandable devices 1200, 1300, 1400, and 1500, the adjustment mechanism 1206, 1306, 1406, and 1506 is in the form of a ratchet member having a variety of configurations and/or designs. Generally, the adjustment mechanisms 1206, 1306, 1406, 1506 include a ratchet coupling carried by respective bases 1207, 1307, 1407, 1507 or arms 1208, 1308, 1408, 1508. Such a configuration may allow for bidirectional relative movement between the bases 1207, 1307, 1407, 1507 and the arms 1208, 1308, 1408, 1508 to selectively move the adjustment mechanisms 1206, 1306, 1406, and 1506 between clamped and released positions. It is appreciated that in some configurations, either one of the base 1207, 1307, 1407, 1507 or the arm 1208, 1308, 1408, and 1508 can carry the respective ratchet components.

With reference to the expandable device 1200 illustrated in FIGS. 23 and 24, the base 1207 includes teeth 1207a that engage corresponding teeth 1208a formed on the arms 1208. Further, the base 1207 defines stops 1210 used to limit movement of the arms 1207 in either direction, thereby serving to define the clamped and released positions.

With reference to the expandable device 1300 illustrated in FIGS. 25 and 26, the base 1307 includes teeth 1307a that engage a pawl 1308a carried by the arms 1308. Further, the base 1307 defines a stop 1310 used to limit movement of the arms 1308 in the inward direction, thereby serving to define the clamped position. Notably, the pawl 1308a is configured to engage these stops 1310. In these examples, the arms 1308 may be releasable from the base 1307, but in other examples, an additional stop may be provided to prevent the arms 1308 from being releasable from the base 1307.

With reference to the expandable device 1400 illustrated in FIGS. 27 and 28, an internal arrangement is provided where the base 1407 includes teeth 1407a that engage corresponding teeth 1408a formed on the arms 1408a. Further, the base 1407 defines a stop 1410 to prevent inward movement of the arms 1408. In some examples, a catch may be provided that limits outward movement of the arms 1408.

With reference to the expandable device 1500 illustrated in FIGS. 29 and 30, an arrangement is provided where the base 1507 includes teeth 1507a that engage corresponding teeth 1508a formed on the arm 1508. Further, in this example, a resilient member or members 1510 is provided to selectively urge the arm 1508 towards or away from the base 1507 as desired.

As illustrated in FIGS. 31-48, alternative accessory attachment devices 1600, 1700, 1800, 1900, 2000, 2100, 2200, 2300, and 2400 (illustrated without a body or button) in the form of expandable grip devices are provided, respectively. It will be appreciated that the expandable devices 1600, 1700, 1800, 1900, 2000, 2100, 2200, 2300, and 2400 illustrated in FIGS. 31-48 may all include similar features to each other and to the expandable devices 100-1500, and thereby elements illustrated in FIGS. 31-48 are designated by similar reference numbers indicated on the embodiment illustrated in FIGS. 1-30, increased by multiples of 100. Accordingly, these features will not be described in substantial detail.

In the expandable devices 1600, 1700, 1800, 1900, 2000, 2100, 2200, 2300, and 2400, the respective adjustment mechanism 1606, 1706, 1806, 1906, 2006, 2106, 2206, 2306, and 2406 is in the form of a spring mechanism having a variety of configurations and/or designs. Generally, the adjustment mechanisms 1606, 1706, 1806, 1906, 2006, 2106, 2206, 2306, and 2406 include a resilient member 1609, 1709, 1809, 1909, 2009, 2109, 2209, 2309, and 2409 similar to the resilient member 209 described with respect to the expandable device 200. The resilient member 1609, 1709, 1809, 1909, 2009, 2109, 2209, 2309, and 2409 is coupling with respective bases 1607, 1707, 1807, 1907, 2007, 2107, 2207, 2307, and 2407 and arms 1608, 1708, 1808, 1908, 2008, 2108, 2208, 2308, and 2408 and exerts an inward force that urges the adjustment mechanisms 1606, 1706, 1806, 1906, 2006, 2106, 2206, 2306, and 2406 towards the clamped position. The resilient members 1609, 1709, 1809, 1909, 2009, 2109, 2209, 2309, and 2409 may take any number of forms such as elastic bands, elongated elastic sheets, coil springs, and the like. Other examples are possible. In the example illustrated in FIGS. 43 and 44, the resilient member 2209 is coupled with the engaging region 2204 via a pivot 2204a to urge each engaging region 2204 inwardly.

As illustrated in FIGS. 49-60, alternative accessory attachment devices 2500, 2600, 2700, 2800, 2900, and 3000 (illustrated without a body or button) in the form of expandable grip devices are provided, respectively. It will be appreciated that the expandable devices 2500, 2600, 2700, 2800, 2900, and 3000 illustrated in FIGS. 49-60 may all include similar features to each other and to the expandable devices 100-2400, and thereby elements illustrated in FIGS. 49-60 are designated by similar reference numbers indicated on the embodiment illustrated in FIGS. 1-48, increased by multiples of 100. Accordingly, these features will not be described in substantial detail.

In the expandable devices 2500, 2600, 2700, 2800, 2900, and 3000, the respective adjustment mechanism 2506, 2606, 2706, 2806, 2906, and 3006 is in the form of a cam mechanism. Generally speaking, the cam mechanism may be movably engaged to adjust the length of the respective platform 2502, 2602, 2702, 2802, 2902, and 3002 between the clamped and released positions. More specifically, the adjustment mechanisms 2506, 2606, 2706, 2806, 2906, and 3006 include a rotatable member 2509, 2609, 2709, 2809, 2909, and 3009 that transforms rotational movement thereof into translational movement of respective arms 2508, 2608, 2708, 2808, 2908, and 3008. The rotational members 2509, 2609, 2709, 2809, 2909, and 3009 include an engaging element 2510, 2610, 2710, 2810, 2910, and 3010 that engages a slot or other component 2508a, 2608a, 2708a, 2808a, 2908a, and 3008a formed on the arm 2508, 2608, 2708, 2808, 2908, and 3008.

As illustrated in FIGS. 61-63, an alternative accessory attachment device in the form of an expandable grip device is provided. It will be appreciated that the expandable device 3100 illustrated in FIGS. 61-63 may include similar features to each other and to the expandable devices 100-3000, and thereby elements illustrated in FIGS. 61-63 are designated by similar reference numbers indicated on the embodiment illustrated in FIGS. 1-60, increased by multiples of 100. Accordingly, these features will not be described in substantial detail.

The expandable device 3100 additionally includes a bumper 3112 having a bumper body 3112a. The bumper body 3112a is adapted to at least partially cover the outer edge 11 of the portable electronic device 10 and to at least partially cover a portion of the engaging region 3104. The bumper body 3112a may be constructed from a resilient material such as rubber, silicone, or the like, and may be stretched to fit over the outer edge 11 of the portable electronic device 10.

In some examples, the bumper 3112 may include a track portion 3113 (FIG. 62) that guides movement of the platform 3102 along the portable electronic device 10. More specifically, the track portion 3113 may be dimensioned to receive and guide movement of the engaging region 3104. In some examples, the engaging region 3104 may not include curved portions, and as such, the track portion 3113 may be in the form of a slot that receives a generally straight portion of the platform 3102. In yet other examples, the engaging regions 3104 may include notches, grooves, and/or cavities that may be aligned either parallel or perpendicular to the device height DH dimension of the portable electronic device. Such notches, grooves, and/or cavities may complement corresponding protrusions and/or cavities formed in the bumper 3112. Other examples and/or arrangements are possible.

In some examples, the device 3100 may further include a cover member 3114. In some examples, the cover member 3114 may be in the form of a generally flat film or sheet constructed from a metallic material, a polymer, or any other suitable material and may at least partially cover the back surface of the portable electronic device 10. In some examples, the cover member 3113 is operably coupled with the bumper 3112 and may be integrally formed therewith. In other examples, the cover member 3113 may be a separate component that is not coupled with the bumper 3112 but instead is retained thereby. In any of these examples, the cover member 3113 may be affixed and/or coupled with the portable electronic device 10 via adhesives and/or any other suitable approach. In examples where the cover member 3113 is not affixed to the portable electronic device 10, it may be positioned to rest on the surface thereof, and the bumper 3112 may provide a sufficient retaining force to prevent the cover member 3113 from moving.

Generally speaking, the platform 3102 is configured to slide over the cover member 3113 via the engaging region 3104 (which may be in the form of a curved member that wraps around the outer edge 11 of the portable electronic device or a planar member that terminates at or near the bumper 3112 and may be retained thereby). In some examples (not illustrated), the cover member 3113 may include a slot or slots to accommodate the engaging region 3104, thereby allowing relative movement between the platform 3102 and the cover member 3113.

Other examples are possible.

The above expandable devices 100-3100 may include any number of additional features as desired to improve and/or increase its functionality. For example, approaches described herein may include a release mechanism to allow the body and the button to be selectively decoupled from the platform. While the embodiments illustrated in FIGS. 1-63 depict a releasable or locking device or mechanism, the mechanism will be described in detail with reference to the expandable device 4300 illustrated in FIGS. 64-79. The releasable or locking device or mechanism 4324 that allows a portion of the expandable device 4300 (e.g., the body 4318 and/or the button 4314) to be disengaged from the platform 4322. In some approaches, the platform 4322 may carry a first release component, and a portion of the button 4318 may carry a second release component. It is understood that in some examples where the storage container is defined by the body and not the button, the lower surface of the body may carry the second release component. In any event, the second release component may be coupled to a rigid, semi-rigid, and/or flexible bottom surface.

While the present application primarily focuses on expandable grip attachments for the accessory attachment devices, in some examples, the release component may be used to selectively retain any number of additional accessories such as, for example, the aforementioned grip members (which may or may not be expandable and collapsible), a battery, a wallet, a water bottle, an auxiliary screen, and the like. Other examples are possible.

Turning to FIGS. 64-68, the thirty-second example accessory attachment device 4300 in the form of an expandable grip device is provided in further detail. As with the expandable devices 100-3100, the expandable device 4300 includes a button 4314, a body 4318 attached to the button 4314, and a platform 4322 that is attachable to a portable electronic device (not shown), a case for a portable electronic device, or other desired component. The body 4318 and/or the button 4314 define the storage receptacle. As before, the body 4318 is movable between an expanded configuration and a collapsed configuration. A locking device 4324, which is hidden from view in FIG. 64 and is shown in FIG. 65, is disposed between the body 4318 and the platform 4322 to rotatably and releasably couple the body 4318 to the platform 4322. The locking device 4324 is movable between an unlocked configuration, in which the body 4318 is removable from the platform 4322, and a locked configuration, in which the body 4318 is secured to the platform 4322. When the body 4318 is in the expanded configuration, the body 4318 may rotate freely about a longitudinal axis A relative to both the platform 4322 and the locking device 4324. The body 4318 is configured to rotate with the locking device 4324, and therefore move the locking device 4324 from a locked configuration to an unlocked configuration, for example, only when the body 4318 is in the collapsed configuration. As shown in FIGS. 66-1068 an engaging member 4330 carried by an inner surface 4334 of the button 4314 is configured to engage with a mating surface 4338 of the locking device 4324 when the device 4300 in in the collapsed configuration. When the button 4314 and body 4318 rotate about the longitudinal axis A in the collapsed configuration, the engaging member 4330 of the button 4314 engages the locking device 4324 such that the locking device 4324 is rotatable relative to the platform 4322 between an unlocked configuration, in which the body 4318 is removable from the platform 4322, and a locked configuration, in which the body 4318 is secured to the platform 4322. The locking device 4324 also rotates about the axis A relative to the platform 4322 from the locked configuration to the unlocked configuration.

As shown in FIG. 65, the locking device 4324 includes a hub 4326 and a connecting disk 4328 rotatably connected to the body 4318. In the locked configuration, the body 4318 is rotatable relative to the locking device 4324 and therefore rotatably coupled to the platform 4322 by way of the locking device 4324. The platform 4322 has a mounting surface 4339 that may include an adhesive adapted to attach the platform 4322 to the portable device or the case for the portable device. The mounting surface 4339 secures the platform 4322 relative to the device to facilitate unlocking and locking the locking device 4324. The hub 4326, the connecting disk 4328, the button 4314, the body 4318, and the platform 4322 are aligned relative to the longitudinal axis A when the expandable device 4300 is in the locked configuration.

The body 4318 can include an accordion-like structure 4318 having a collapsible wall 4320. The body 4318 is movable between the expanded configuration, as shown in FIGS. 64-67, and collapsed configuration, as shown in FIG. 68. The body 4318 is symmetrical about the longitudinal axis A, and includes a first end 4340 distal to the platform 4322 and a second end 4342 proximate to the platform 4322. When the button 4314 is attached to the first end 4340 of the body 4318, the wall 4320 of the body 4318 and the button 4314 define a chamber 4356. The body 4318 includes an aperture 4358 formed in the second end 4342 of the body 4318 such that the locking device 4324 may be partially disposed both internally and externally relative to the body 4318. At the second end 4342 of the body 4318, the chamber 4356 has a volume sized to receive the connecting disk 4328. The body 4318 can be made of a flexible material, such as polyester-based thermoplastic polyurethane elastomer, that may be formed by injection molding, thermoforming, or compression molding, or may be any equivalently functional material suitable for its intended purpose.

As illustrated in FIGS. 66 through 68, the connecting disk 4328 of the locking device 4324 carried by the second end 4342 of the body 4318 and is disposed in the chamber 4356 of the body 4318 adjacent to the second end 4342. In this configuration, the mating surface 4338 of the connecting disk 4328 faces the inner surface 4334 of the button 4314, and a second mating surface 4360 extends through the aperture 4358 of the second end 4342 of the body 4318 for coupling to the hub 4326. The connecting disk 4328 is disposed within the body 4318 and is rotatable relative to the body 4318. The connecting disk 4328 rotates with the body 4318 when the button 4314 is attached to the first end 4340 of the body 4318 and engages with the first mating surface 4338 of the connecting disk 4328.

The engaging member 4330 of the button 4314 is particularly suited to connect with the mating surface 4338 of the connecting disk 4328. As such, locking device 4324 of the device 4300 is beneficially constructed so that the body 4318 does not easily detach from the platform 4322 when the device 4300 is in use. The button 4314 of the device 4300 acts as a key to unlock or lock the body 4318 from or to the platform 4322 when the button 4314 engages the locking device 4324. In some examples where the locking device 4324 is disposed below the body (as opposed to the button), the body acts as a key to unlock or lock the body from or to the platform.

As shown in FIG. 68, the engaging member 4330 of the button 4314 and the first mating surface 4338 of the locking device 4324 are arranged so that the engaging member 4330 and the first mating surface 4338 interlock (e.g., mesh, overlap, engage, mate, couple) when the inner surface 4334 of the button 4314 is adjacent to the mating surface 4338. The inner surface 4334 of the button 4314 is shown in greater detail in FIG. 69. The engaging member 4330 includes a plurality of protrusions 4344 (e.g., teeth, ribs, studs, pegs, etc.) separated by a plurality of spaces 4348 (e.g., grooves, notches, dimples, etc.), which may be arranged in a predetermined pattern or configuration that corresponds to the mating surface 4338 of the connecting disk 4328. In this example, the engaging member 4330 includes a plurality protruding teeth 4344 evenly spaced by the plurality of openings or grooves 4348 in the shape of a ring. The engaging member 4330 is disposed about the longitudinal axis A, and is symmetrical such that the button 4314 may easily mesh with the first mating surface 4338 of the connecting disk 4328.

FIG. 70 illustrates the mating surface 4338 of the connecting disk 4328 is arranged in a pattern of protruding teeth 4352 (e.g., protrusions, ribs, studs, pegs, etc.), which are evenly spaced by a plurality of grooves 4354 (e.g., spaces, notches, dimples, etc.). The first mating surface 4338 is symmetrical about the longitudinal axis A such that the button 4314 may easily mesh with the first mating surface 4338 of the connecting disk 4328. Briefly returning to FIGS. 66-68, the plurality of protrusions 4352 of the connecting disk 4328 are aligned, and sized to fit, within the spaces 4348 of the engaging member 4330 of the button 4314. Likewise, the plurality of grooves 4354 are aligned, and sized to receive, the plurality of protrusions 4344 of the button 4314. Thus, when the body 4318 is in the collapsed configuration, the plurality of protrusions 4344, 4352 of the button 4314 and the mating surface 4338 of the locking device 4324 are interlocked and positioned to engage when the button 4314 is rotated about the longitudinal axis A. In another example, the mating surface 4338 and the engaging member 4330 interlock or otherwise engage via an alternative locking configuration.

In FIG. 71, the second mating surface 4360 of the connecting disk 4328 is shown. The second mating surface 4360 includes a flat area 4362, a protruding portion 4363 surrounded by the flat area 4362 and extending axially away from the flat area 4362 of the disk 4328. The flat area 4362 is configured to lay flat against an interior surface of the second end 4342 of the body 4318 and the protruding portion 4363 is configured to at least partially extend through the aperture 4358 of the body 4318. The flat area 4362 includes a smooth surface to reduce friction between the disk 4328 and the body 4318 such that the connecting disk 4328 is free to rotate relative to the body 4318 when the disk 4328 is disposed within the chamber 4356. A distal end 4364 of the protruding portion 4363 includes a plurality of angled tips. The angled tips 4364 may be configured to flex, bend, or otherwise deform to mate with the hub 4326. Once the protruding portion 4363 engages the hub 4326, the hub 4326 and the connecting disk 4328 may be fixed (e.g., welded, fused, etc.) together to move as a unitary locking device 4324. Alternatively, the hub 4326 and connecting disk 4328 can be integrally formed. Unlike the flat area 4362, the distal end 4364 may be a textured material configured to frictionally engage with the hub 4326 so that the connecting disk 4328 rotates the hub 4326 when the disk 4328 and hub 4326 are engaged.

In FIGS. 72 and 73, the hub 4326 is shown in greater detail. The hub 4326 includes a body 4365 and first and second radial wings 4366 and 4368 that extend outwardly from the body 4365. The wings 4366 and 4368 are disposed on opposing sides of the body 4365, and may be a resilient material such that the wings 4366 and 4368 may deform (e.g., bend, flex) when the wings 4366 and 4368 engage the platform 4322. The body 4365 includes a first surface 4370 and a second surface 4372 opposite the first surface 4370. The first surface 4370 is configured to mate with the second mating surface 4360 of the connecting disk 4328. More particularly, an opening 4371 formed in the first surface 4370 is sized and shaped to receive the protruding portion 4363 of the second mating surface 4360 of the connecting disk 4328. As shown in FIG. 73, the hub 4326 includes first and second curved notches or ramps 4373, 4374 formed in the second surface 4372 to facilitate disengagement between the platform 4322 and the hub 4326 when the locking device 4324 rotates relative to the platform 4322. Specifically, the notches 4373, 4374 are formed to slide against protrusions 4376, 4378 extending from the platform 4322 when the locking device 4324 rotates a quarter turn (i.e., 90 degrees) about the longitudinal axis A. First and second detents 4384, 4386 are formed in the second surface 4372 of the hub 4326 and are shaped to engage with first and second protrusions 4376, 4378 of the platform 4322 when the locking device 4324 is in the locked configuration. In another example, the second surface 4372 of the body 4365 may have only one notch 4373 or 4374 or no notches. In the case where the hub 4326 provide only one notch 4373, the portion of the second surface 4372 opposite disposed from the notch 4373 may be flat or coplanar with the second surface 4372.

This configuration may facilitate removal of the body 4318 from the platform 4322. For example, as the locking device 4324 is rotated out of locking engagement with the platform 4322, the protrusion 4376 or 4378 of the platform 4394 may bias the second surface 4372 of the hub 4326 upward and away from the platform 4322.

The hub 4326 and the platform 4322 are arranged to rotatably couple to lock the body 4318 to the platform 4322. The first and second wings 4366 and 4368 are deformable such that they may deflect from their original position when the wings 4366 and 4368 engage first and second shelves 4380, 4382 of the platform 4322 as the locking device 4324 moves from the unlocked configuration to the locked configuration. The detents 4384, 4386 formed in the second surface 4372 of the hub 4326 are configured to engage with the platform 4322 in the locked configuration. Specifically, each detent 4384, 4386 is partially formed in one of the two wings 4366, 4368. It will be appreciated that the second shelf 4382 is substantially similar to the first shelf 4380 and the wing 4368 is substantially similar to the wing 4366, such that any details of the first shelf 4380 and the first wing 4366 discussed below apply equally to the second shelf 4382 and the second wing 4368, respectively. In the illustrated expandable device 4300, the locking device 4324 includes two wings 4366 and 4368 and the platform 4322 includes two shelves 4380 and 4382 corresponding to the wings 4366 and 4368 of the locking member 4324. However, in another example device, the locking device 4324 may have one wing or more than two wings, and the platform 4322 may have the same number of corresponding shelves. Likewise, the platform 4322 includes two protrusions 4376, 4378 and the hub 4326 includes two detents 4384, 4386 corresponding to the protrusions 4376, 4378. However, in another example device, the hub 4326 may include one detent or more than two detents, and the platform may have the same number of corresponding protrusions. The hub 4326 is preferably made of a durable plastic, such as polyethylene, or a harder plastic, such as polycarbonate, that may be formed by injection molding, thermoforming, or compression molding, but may instead be formed of any other suitable and durable material including thermoplastic polyurethane, metal, fiberglass, or any combination of these materials, or any equivalently functional materials suitable for its intended purpose.

As shown in FIGS. 66-68, the hub 4326 is coupled to the platform 4322 when the locking device is in the locked configuration. The platform 4322 includes an outer surface 4387 and a collar 4388 extending away from the surface 4387. The collar 4388 defines a cavity 4390. The second shelf 4382 oppositely disposed from the first shelf 4380 is configured to slidably receive one of the wings 4366 and 4368 of the hub 4326. The shelves 4380 and 4382 are configured to engage one of the wings 4366 and 4368 of the locking member 4324 when the locking member 4324 is in the locked configuration. A surface of each shelf 4380 and 4382 inhibits axial movement of the locking device 4324 relative to the platform 4322 when the locking device 4324 is in the locked configuration. The first and second wings 4366 and 4368 move out of engagement with the shelves 4380 and 4382 when the hub 4326 is rotated.

As illustrated in FIGS. 74 through 76, the first exemplary platform 4322 includes the first shelf 4380 extending radially inwardly from the collar 4388 and into a cavity 4390 formed in the platform 4322. At least a portion of the locking device 4324 is adapted to be removably disposed in the cavity of the platform 4322 for releasably coupling the body 4318 to the platform 4322. The cavity 4390 is partially defined by a non-circular opening 4392, as shown in FIG. 74, and is shaped to receive the first and second wings 4366 and 4368 of the hub 4326. In particular, the opening 4392 is defined by first and second opposing shelves 4380, 4382, and an interior wall 43100 of the collar 4388. The platform 4322 also includes a base 4394 that is recessed from the collar 4388 and defines a lower boundary of the cavity 4390 of the platform 4322. The base 4394 is connected to the inner wall 43100 of the platform 4322 such that the base 4394 may be co-planar with the mounting surface 4339 of the platform 4322, as shown in FIG. 75. The base 4394 also includes first and second protrusions 4376, 4378 extending axially into the cavity 4390 and spaced radially inwardly relative to the shelves 4380, 4382, respectively. The base 4394 is connected to the inner wall 4100 at opposing ends, which are 90 degrees offset from the first and second shelves 4380, 4382. Above the opposing ends of the base 4394, the collar 4388 defines a radially recessed inner wall 4100, providing a clearance for the hub 4326. So configured, the radial wings 4366, 4368 of the hub 4328 may slide into the opening 4392 until the radial wings 4366, 4368 are beneath a reference plane on which the shelves 4380, 4382 are disposed. The base 4394 is disconnected from the inner wall 4100 directly below the first and second shelves 4380, 4382 such that the base 4394 may flex downward relative to the shelves 4380, 4382 when the second surface 4372 of the hub 4326 engages the base 4394.

As shown in FIGS. 75 and 76, the first shelf 4380 of the platform 4322 includes a first surface 4104 that faces the second end 4342 of the body 4318, and a second surface 4108 that engages with one of the first and second wings 4366 and 4368 of the locking member 4324 when the locking member 4324 moves from the unlocked configuration to the locked configuration. The platform 4322 is preferably made of a durable plastic, such as polyethylene, or a harder plastic, such as polycarbonate, that may be formed by injection molding, thermoforming, or compression molding, but may instead be formed of any other suitable and durable material including thermoplastic polyurethane, metal, fiberglass, or any combination of these materials, or any equivalently functional materials suitable for its intended purpose.

To couple the locking member 4324 to the platform 4322, the hub 4326 is disposed through the opening 4392 and into the cavity 4390 of the platform 4322 such that the locking member 4324 is at least partially disposed below first and second shelves 4380, 4382. The locking member 4324 is rotated (e.g., 90 degrees) in either the clockwise or counterclockwise direction about the longitudinal axis A. As the locking member 4324 is rotated, the first wing 4366 of the hub 4326 of the locking member 4324 slides against the shelf 4380 of the platform 4322 until the protrusion 4376 of the base 4394 snaps into the detent 4384 of the second surface 4372 of the hub 4326. Additionally, the hub 4326 may deflect or displace the base 4394 until the protrusion 4376 and the detent 4384 are engaged. The base 4394 may be a resilient material such that the base 4394 may deform (e.g., bend, flex) when engaged by the hub 4326. In one example, the base 4394 may bend or flex along a flexible hinge formed in the base 4394 extending between opposing sides of the inner wall 4100 (i.e., where the base 4394 connects to the platform 4322. It will be appreciated that the second shelf 4382 is substantially similar to the first shelf 4380, the second wing 4368 is substantially similar to the first wing 4366, the second detent 4386 is substantially similar to the first detent 4384, and the second protrusion 4378 is substantially similar to the first protrusion 4376, such that any details of the first shelf 4380, first wing 4366, first detent 4384, and the first protrusion 4376 discussed above apply equally to the second shelf 4382, the second wing 4368, the second detent 4386, and the second protrusion 4378, respectively.

The mating relationships between the button 4314 and the connecting disk 4328, the connecting disk 4328 and the hub 4326, and the hub 4326 and the platform 4322 may be configured to provide any number of different mating engagements. For example, the hub 4326 may include one or more protrusions extending from its second surface 4372 to couple to one or more detents formed in the base 4394 of the platform 4322. In another example, the second mating surface 4360 of the connecting disk 4328 may not extend through the aperture 4358 formed in the second end 4342 of the body 4318, but instead, the first surface 4370 of the hub 4326 may include a portion that extends into the aperture 4358 of the body 4318 to couple with the second mating surface 4360 of the connecting disk 4322. Non-limiting examples of the configuration or mating relationship between the locking member 4324 and the platform 4322 and/or other components of the device 4300 are disclosed in U.S. application Ser. No. 15/864,402, filed Jan. 8, 2018, U.S. application Ser. No. 15/864,509, filed Jan. 8, 2018, and U.S. application Ser. No. 15/993,458, filed May 30, 2018, the entire disclosures of which are incorporated herein by reference.

The expandable device 4300 may be moved from the locked configuration to the unlocked configuration by overcoming the frictional forces between the mating surfaces of the locking device 4324 and the platform 4322. Generally speaking, a user of the expandable device 4300 may rotate the locking device 24 from the locked configuration to the unlocked configuration by collapsing the expandable device 4310 such that the button 4314 engages with the connecting disk 4328 of the locking device 4324, and then by grabbing or grasping the button 4314 or body 4318 and moving, e.g., rotating or twisting, the button 4314 or body 4318 a quarter turn (i.e., 90 degrees) in either the clockwise or counterclockwise direction about the longitudinal axis A. The button 4314 engages with the locking device 4324 to rotate the locking device 4324 with the button 4314 and body 4318. In turn, the connecting disk 4328 transfers the rotational motion from the button 4314 to rotate the hub 4326 of the locking device 4324 out of engagement with the platform 4322. Once the locking member 4324 is in the unlocked configuration, the user may pull the body 4318 away and out of the cavity 4390 and through the opening 4392 of the platform 4322 to lock the body 4318 to the platform 4322.

The device 4300 may be assembled by connecting the connecting disk 4328 to the second end 4342 of the body 4318 by disposing the connecting disk 4328 into the chamber 4356 of the body 4318. The second mating surface 4360 is coupled to the first surface 4370 of the hub 4326 such that the hub 4326 and the connecting disk 4328 form a unitary locking device 4324. The body 4318 may be coupled to the platform 4322 by disposing the hub 4326 into the cavity 4390 of the platform 4322.

FIGS. 77 and 78 illustrate another example device 4400 constructed in accordance with the teachings of the present disclosure. The fourth example device 4400 is similar to the device 4300 of FIGS. 64-68. Thus, for ease of reference, and to the extent possible, the same or similar components of the device 4400 will retain the same reference numbers as outlined above with respect to the devices 100-3100 and 3400, although the reference numbers will be increased by a multiple of 100.

A button 4414 of the fourth device 4400 includes an engaging member 4430 having a non-circular cross-sectional shape. The engaging member 4430 includes a plurality of sides 4431 configured to engage with a corresponding opening 4448 or indentation formed in a first mating surface 4438 of a locking device 4424. As shown in FIG. 79, a connecting disk 4428 of the locking device 4424 includes the first mating surface 4438 having a non-circular shape sized to receive the engaging member 4430 of the button 4414 when the device 4410 is in a collapsed configuration. A body 4418, a platform 4422, and a hub 4426 may be substantially similar to the body 318, platform 322, and hub 326 of the third device 300 previously described with reference to FIGS. 64-76. The mating surface 4438 of the locking device 4424 and the engaging member 4430 of the button 4414 may be any number of shapes and structures that facilitate engagement between the locking device 4424 and the button 4414. As with any of the preceding examples, a storage receptacle 4402 may be formed by the button 4412 and/or the body 4418.

In some instances, the expandable grip accessory of the current disclosure may be in the form of a commercially available grip and stand product such as that available on www.popsockets.com. For example, U.S. Pat. No. 8,560,031, filed on Feb. 23, 2012; U.S. Pat. No. 9,970,589, filed on Nov. 9, 2017; U.S. application Ser. No. 15/615,900, filed on Jun. 7, 2017; U.S. application Ser. No. 15/679,934, filed on Aug. 17, 2017; U.S. application Ser. No. 15/803,410, filed on Nov. 3, 2017; U.S. application Ser. No. 15/808,076, filed on Nov. 9, 2017; U.S. application Ser. No. 15/864,402, filed on Jan. 8, 2018; U.S. application Ser. No. 15/864,509, filed on Jan. 8, 2018; U.S. application Ser. No. 15/906,920, filed on Feb. 27, 2018; U.S. application Ser. No. 15/922,601, filed on Mar. 15, 2018; U.S. application Ser. No. 15/952,025, filed on Apr. 12, 2018; U.S. application Ser. No. 15/993,458, filed on May 30, 2018; and U.S. application Ser. No. 16/001,723, filed on Jun. 6, 2018 each describe suitable expandable grip and stand product, which also incorporate collapsible mechanisms, the entirety of each being hereby incorporated by reference.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. An accessory attachment device for attachment to a portable electronic device, the grip device comprising:
a platform having an elongated length, a platform height dimension, a top side, a bottom side, and at least one engaging region, the at least one engaging region adapted to engage an outer edge of the portable electronic device or an outer edge of a case for the portable electronic device;
wherein the platform height dimension is less than a device height dimension of the portable electronic device.

2. The accessory attachment device of claim 1, further comprising a grip device adapted to be removably coupled with the accessory attachment device, the grip device comprising:
a body including a first end, a second end, and a longitudinal axis, the second end of the body being operably coupled with the platform, the body being movable between an expanded configuration and a collapsed configuration; and
a button operably coupled with the first end of the body.

3. The accessory attachment device of claim 1, further comprising a plurality of engaging regions disposed on opposing ends of the elongated length of the platform.

4. The accessory attachment device of claim 1, wherein the at least one engaging region is adapted to frictionally engage the outer edge of the portable electronic device or the outer edge of the case for the portable electronic device.

5. The accessory attachment device of claim 4, wherein the platform is slidably coupled with the portable electronic device.

6. The accessory attachment device of claim 1, wherein the body further includes a release mechanism adapted to releasably couple the body with the platform.

7. The accessory attachment device of claim 1, wherein the body and the button cooperate to define a storage receptacle.

8. The accessory attachment device of claim 1, wherein the at least one engaging region includes a gripping material that contacts the outer edge of the portable electronic device or the outer edge of the case for the portable electronic device.

9. A accessory attachment device for attachment to a portable electronic device, the accessory attachment device comprising:
a platform having an elongated length, a platform height dimension, a top side, a bottom side, an adjustment mechanism, and at least one engaging region, the at least one engaging region adapted to engage an outer edge of the portable electronic device or an outer edge of a case for the portable electronic device;
wherein the adjustment mechanism is adapted to selectively adjust a dimension of the elongated length of the platform between a clamped position and a released position.

10. The accessory attachment device of claim 9, further comprising a grip device adapted to be removably coupled with the accessory attachment device, the grip device comprising:
a body including a first end, a second end, and a longitudinal axis, the second end of the body being operably coupled with the platform, the body being movable between an expanded configuration and a collapsed configuration; and
a button operably coupled with the first end of the body.

11. The accessory attachment device of claim 9, wherein the adjustment mechanism comprises a base and at least one arm movable relative to the base.

12. The accessory attachment device of claim 9, wherein the adjustment mechanism further comprises a resilient member operably coupled with the base and the at least one arm to urge the base and the at least one arm towards the clamped position.

13. The accessory attachment device of claim 9, wherein the platform height dimension is less than a device height dimension of the portable electronic device.

14. The accessory attachment device of claim 9, wherein the at least one engaging region is adapted to frictionally engage the outer edge of the portable electronic device or the outer edge of the case for the portable electronic device.

15. The accessory attachment device of claim 9, wherein the body further includes a release mechanism adapted to releasably couple the body with the platform.

16. The accessory attachment device of claim 9, wherein the adjustment mechanism further comprises a locking mechanism adapted to selectively retain the platform in the clamped position or the released position.

17. The accessory attachment device of claim 9, wherein the adjustment mechanism further comprises at least one of:
a compliant member urged towards the clamped position;
an adhesive member;
a ratchet mechanism adapted to selectively retain the platform in the clamped position or the released position;
a spring mechanism adapted to selectively retain the platform in the clamped position or the released position; or
a cam mechanism adapted to selectively retain the platform in the clamped position or the released position.

18. An accessory attachment device for attachment to a portable electronic device, the accessory attachment device comprising:
a platform having an elongated length, a platform height dimension, a top side, a bottom side, and at least one engaging region, the at least one engaging region adapted to engage an outer edge of the portable electronic device;
a bumper having a bumper body, the bumper body adapted to at least partially cover an outer edge of the portable electronic device and to at least partially cover a portion of the at least one engaging region.

19. The accessory attachment device of claim 18, further comprising a grip device adapted to be removably coupled with the accessory attachment device, the grip device comprising:
a body including a first end, a second end, and a longitudinal axis, the second end of the body being operably coupled with the platform, the body being movable between an expanded configuration and a collapsed configuration; and
a button operably coupled with the first end of the body.

20. The accessory attachment device of claim 18, further comprising a track portion formed on the bumper to guide movement of the platform along the portable electronic device.

21. The accessory attachment device of claim 18, wherein the platform height dimension is less than a device height dimension of the portable electronic device.

22. The accessory attachment device of claim 18, wherein the body further includes a release mechanism adapted to releasably couple the body with the platform.

23. The accessory attachment device of claim 18, further comprising a cover member adapted to at least partially cover a surface of the portable electronic device.

24. The accessory attachment device of claim 23, wherein the cover member includes a slotted portion to accommodate the at least one engaging region.
